(19) United States
(12) Patent Application Publication
(10) Pub. No.: US 2020/0368085 A1
(43) Pub. Date: Nov. 26, 2020

(54) RIDE VEHICLE PASSENGER TRANSFER SYSTEMS AND METHODS

(71) Applicant: Universal City Studios LLC, Universal City, CA (US)

(72) Inventor: Luke Vincent Santore, Orlando, FL (US)

(21) Appl. No.: 16/569,398

(22) Filed: Sep. 12, 2019

Related U.S. Application Data
(60) Provisional application No. 62/852,022, filed on May 23, 2019.

(51) Int. Cl. A61G 3/02; A63G 4/00

(52) U.S. Cl. CPC A61G 3/02; A63G 4/00

(57) ABSTRACT

A transfer device configured to support a passenger for transfer from a mobile chair to a ride seat of a ride vehicle includes a frame coupled to a seating portion, where the seating portion is configured to support the passenger. The transfer device includes at least one wheel coupled to the frame. The transfer device also includes a mounting bracket coupled to the frame and configured to reversibly engage with the ride vehicle. In an engaged configuration, the transfer device is coupled to the ride vehicle such that a seating pan of the seating portion is aligned with the ride seat of the ride vehicle. The transfer device, when engaged, is configured to travel with the ride vehicle while the ride vehicle travels along a track.

### CROSS-REFERENCE TO RELATED APPLICATIONS

This application claims priority to and the benefit of U.S. Provisional Application No. 62/852,022, entitled “RIDE VEHICLE PASSENGER TRANSFER SYSTEMS AND METHODS,” filed May 23, 2019, which is hereby incorporated by reference in its entirety for all purposes.

### BACKGROUND

The present disclosure relates generally to the field of amusement parks. More particularly, embodiments of the present disclosure relate to systems and methods for transferring passengers into and out of ride vehicles of amusement park ride systems.

Since the early twentieth century, amusement parks (e.g., theme parks) have substantially grown in popularity. Generally, amusement parks include a wide variety of attraction types useful in providing enjoyment to guests (e.g., families and/or people of all ages) of the amusement park. Indeed, the attractions may include a wide variety of ride vehicles configured to provide varying ride experiences. In some instances, wheelchair-using passengers may require extra assistance, time, and effort to board the ride vehicles (e.g., from a mobile chair or other wheelchair), if they are able to board the ride vehicles at all. For some amusement parks, a select few attractions may include ride vehicles specifically designed to accommodate wheelchair-using passengers. For example, the ride vehicles of such attractions may include a ride seat or section configured to secure a wheelchair of a wheelchair-using passenger to the ride vehicle. Accordingly, the ride vehicle may transport the wheelchair-using passenger and their wheelchair along a path (e.g., a track) of the amusement park attraction. Various constraints, such as dynamics of the attraction, may differ widely between attractions, and therefore necessitate a unique design for each attraction in aiding the boarding of wheelchair-using passengers. As such, the design and implementation of such ride vehicles may be costly, which may limit the number of such attractions included in an amusement park.

### SUMMARY

Certain embodiments commensurate in scope with the present disclosure are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

In an embodiment, a transfer device configured to support a passenger for transfer from a mobile chair to a ride seat of a ride vehicle includes a frame coupled to a seating portion, where the seating portion is configured to support the passenger. The transfer device includes at least one wheel coupled to the frame. The transfer device also includes a mounting bracket coupled to the frame and configured to reversibly engage with the ride vehicle. In an engaged configuration, the transfer device is coupled to the ride vehicle such that a seating pan of the seating portion is aligned with the ride seat of the ride vehicle. The transfer device, when engaged, is configured to travel with the ride vehicle while the ride vehicle travels along a track.

In an embodiment, a passenger transfer system includes a ride vehicle configured to move along a track of an amusement park attraction and a ride vehicle seating pan configured to support a passenger. The passenger transfer system includes a loading belt positioned adjacent to the track and having a loading surface configured to translate along the track with the ride vehicle. The passenger transfer system also includes a transfer device configured to removably couple to the ride vehicle, where the transfer device is configured to support the passenger as the passenger transfers from a mobile chair positioned on the loading belt to the ride vehicle seating pan of the ride vehicle.

In an embodiment, a transfer device configured to support a passenger as the passenger transfers from a mobile chair to a ride vehicle seating pan of a ride vehicle includes a frame having a lower chassis, where the lower chassis includes a foot and at least one wheel rotatably coupled to the lower chassis. The frame also includes a seating portion coupled to the lower chassis and configured to support the passenger. The transfer device includes a mounting bracket coupled to the frame and configured to engage with the ride vehicle in an engaged configuration and to be removed from the ride vehicle in a disengaged configuration. In the engaged configuration, the transfer device is coupled to the ride vehicle and configured to travel with the ride vehicle. At least a portion of the ride vehicle seating pan is aligned with a seating pan on the transfer device in the engaged configuration.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic top view of an embodiment of a ride system, in accordance with aspects of the present disclosure;

FIG. 2 is a perspective view of an embodiment of a passenger transfer device in an engaged configuration with a ride vehicle, in accordance with aspects of the present disclosure;

FIG. 3 is a perspective view of an embodiment of a passenger transfer device, in accordance with aspects of the present disclosure;

FIG. 4 is a perspective view of an embodiment of a frame of a passenger transfer device, in accordance with aspects of the present disclosure;

FIG. 5 is a side view of an embodiment of a passenger transfer device, in accordance with aspects of the present disclosure;

FIG. 6 is a perspective view of an embodiment of a passenger transfer device in an engaged configuration with a ride vehicle, in accordance with aspects of the present disclosure;

FIG. 7 is a perspective view of an embodiment of a portion of a passenger transfer device in an engaged configuration with a ride vehicle, in accordance with aspects of the present disclosure; and

FIG. 8 is a perspective view of an embodiment of a mounting bracket for a passenger transfer device, in accordance with aspects of the present disclosure.

### DETAILED DESCRIPTION

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

Provided herein is a transfer device (e.g., a passenger transfer device) configured to aid in the transfer of a wheelchair-using passenger from a wheelchair into a ride vehicle. Accordingly, the wheelchair-using passenger may board a conventional ride seat of the ride vehicle while a wheelchair or other mobile chair of the wheelchair-using passenger is not loaded into the ride vehicle. Particularly, as discussed below, the transfer device may be configured to bridge a gap between the wheelchair of the wheelchair-using passenger and the ride vehicle to which the wheelchair-using passenger is attempting to transfer. The transfer device may be configured to engage with the ride vehicle such that the transfer device is at least partially supported by the ride vehicle. The transfer device may be configured to provide support to the wheelchair-using passenger as the wheelchair-using passenger moves across the transfer device from the wheelchair and into the ride vehicle. To this end, the transfer device may facilitate transfer of the wheelchair-using passenger to and from a ride seat of the ride vehicle. Additionally, the transfer device may enable various amusement park attractions to comply with the Americans with Disabilities Act (ADA).

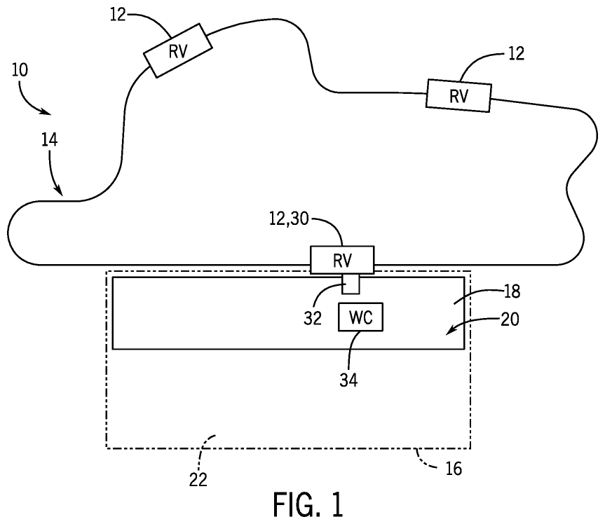

Turning now to the drawings, FIG. 1 is a schematic of an embodiment of a ride system 10 (e.g., an attraction) of an amusement park. In the illustrated embodiment, the ride system 10 includes one or more ride vehicles 12 that are configured to travel along a track 14 (e.g., a path) of the ride system 10. A portion of the track 14 is configured to extend along and/or to extend through an exchange area 16 of the ride system 10. The exchange area 16 is configured to facilitate loading and unloading of passengers (e.g., guests of the amusement park) from the ride vehicles 12. For example, when approaching and/or entering the exchange area 16, the ride vehicles 12 may slow to a loading speed, which may be less than a riding speed at which the ride vehicles 12 travel along a remaining portion of the track 14. The exchange area 16 may include a translating belt 18 (e.g., a loading belt) that is positioned adjacent to the track 14 and configured to provide a loading/unloading surface 20 from which passengers may easily board into or dismount from the moving ride vehicles 12. In particular, the belt 18 may operate at a traveling speed that enables the loading/unloading surface 20 to translate along a stationary platform 22 of the exchange area 16 at a speed that is substantially equal to the loading speed of the ride vehicles 12.

Accordingly, to board one of the ride vehicles 12, a passenger enters the unloading/loading surface 20 from the stationary platform 22 such that the belt 18 may move the passenger along the exchange area 16 and with the ride vehicle 12. Accordingly, the belt 18 may ensure that a relative speed (e.g., a speed differential) between the passenger positioned on the belt 18 and a particular ride vehicle 12, referred to hereinafter as a ride vehicle 30, traveling along the track 14 in the exchange area 16 is relatively negligible, thereby facilitating boarding of the passenger into the ride vehicle 30. Indeed, the passenger may step into or otherwise enter a cabin of the ride vehicle 30 without manually traveling (e.g., walking) alongside the ride vehicle 30 at the loading speed of the ride vehicle 30. The ride vehicle 30 may subsequently exit the exchange area 16 and travel along the track 14 upon completion of the boarding operation. When returning to the exchange area 16, the passenger may dismount from the ride vehicle 30 in the reverse order discussed above. Specifically, the passenger may dismount from the ride vehicle 30 onto the belt 18 before stepping off of the belt 18 and onto the stationary platform 22.

In some instances, a wheelchair-using passenger may attempt to board into or dismount from one of the moving ride vehicles 12, such as the ride vehicle 30. The wheelchair-using passenger may utilize a transfer device 32 to increase an ease and an efficiency of boarding into or dismounting from the ride vehicles 12. For example, as discussed in detail below, the transfer device 32 is configured to removably couple to any of the ride vehicles 12, such as the ride vehicle 30, thereby enabling an operator (e.g., an employee operating the ride system 10) to engage (e.g., toollessly and/or removably/reversibly couple) the transfer device 32 with the ride vehicle 30 as the ride vehicle 30 enters the exchange area 16 from a remaining portion of the track 14. As such, the ride vehicle 30 may move the transfer device 32 along the exchange area 16 at the loading speed.

To board a wheelchair-using passenger into the ride vehicle 30, the wheelchair-using passenger may be wheeled from the stationary platform 22 onto the loading/unloading surface 20 of the belt 18 (e.g., via a wheelchair 34 or other mobile chair) and positioned adjacent to the transfer device 32 such that the transfer device 32 is positioned between the wheelchair 34 and the ride vehicle 12. The transfer device 32 enables the wheelchair-using passenger to dismount from the wheelchair 34 and to temporarily support themselves on the transfer device 32. Accordingly, the wheelchair-using passenger may subsequently board the ride vehicle 30 from the transfer device 32. Upon completion of the boarding procedure, the transfer device 32 may be decoupled from the ride vehicle 30 (e.g., via assistance from the operator) and the wheelchair 34 of wheelchair-using passenger may be removed from the belt 18, thereby enabling the wheelchair-using passenger to enjoy the ride provided by the ride system 10. The wheelchair-using passenger may utilize the transfer device 32 to dismount from the ride vehicle 30 upon completion of the ride by executing the aforementioned steps in reverse order.

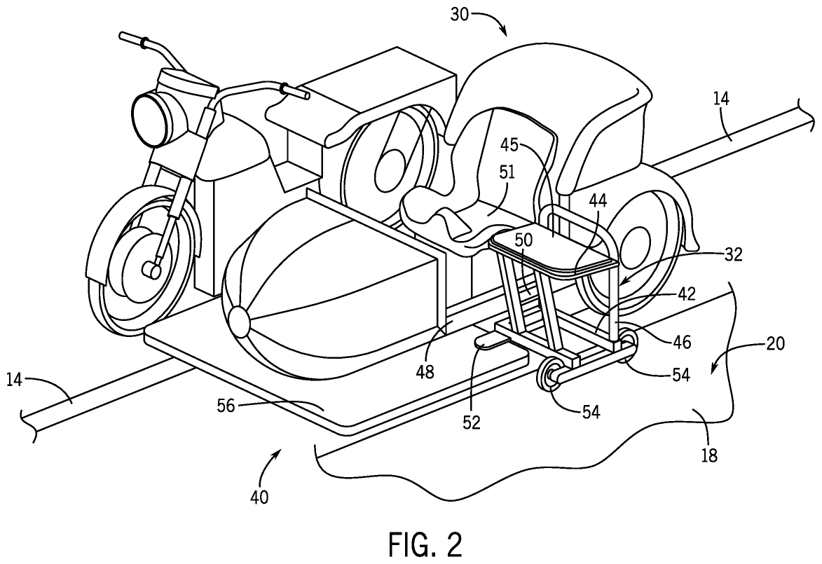

FIG. 2 is a perspective view of an embodiment of the transfer device 32 and the ride vehicle 30 in an engaged configuration 40. In the illustrated embodiment, the transfer device 32 includes a lower chassis 42 and a seating structure 44 (e.g., a seating portion) coupled to a seating pan 45. The seating structure 44 may collectively form a frame 46 of the transfer device 32. The frame 46 may be configured to interface (e.g., removably couple) with one or more areas of the ride vehicle 30 to enable an operator, guest, or other person using the transfer device 32 to quickly couple or decouple the transfer device 32 from a chassis 48 or another area of the ride vehicle 30. Particularly, as discussed below, the frame 46 may include an interface feature 50 that is configured to enable removable coupling of the transfer device 32 to the ride vehicle 30. Indeed, the interface feature 50 may be configured to enable persons utilizing the transfer device 32 to couple the transfer device 32 to and to decouple the transfer device 32 from the ride vehicle 30 without the use of dedicated tools or equipment. In an embodiment, while the transfer device 32 couples to and engages with the ride vehicle 30, the transfer device 32 may not include features that engage with or couple to the mobile chair 34. That is, the transfer device 32 may be configured to be used in conjunction with a variety of mobile chairs 34 of various configurations.

When in the engaged configuration 40, the seating structure 44 is aligned at least in part with a ride vehicle seating pan 51 of the ride vehicle 30. That is, the transfer of the passenger from the seating pan 45 of the transfer device 32 to the ride vehicle seating pan 51 may occur by sliding the passenger across the seating pan 45 and across or down into the ride vehicle seating pan 51. Accordingly, when the transfer device 32 is engaged with the ride vehicle 30, the ride vehicle seating pan 51 may be generally planar with the seating pan 45 of the transfer device 32. In an embodiment, the ride vehicle seating pan 51 may be contoured or nonplanar. However, when the transfer device 32 is engaged with the ride vehicle 30, height differences between the ride vehicle seating pan 51 and the seating pan 45 of the transfer device 32 may be within a predetermined tolerance (e.g., 10 cm or less) in either an up or down (toward the loading surface 22) direction.

The transfer device 32 may include a foot 52 (e.g., a protrusion extending from the lower chassis 42) and one or more wheels 54 that are configured to support a weight of the transfer device 32 and a weight of a wheelchair-using passenger that may be seated on the transfer device 32. For example, in the engaged configuration 40 of the transfer device 32, the foot 52 may be configured to engage with (e.g., rest on) a portion of the ride vehicle 30 chassis 48, such as a barge board 56, while the wheels 54 engage with (e.g., rest on) the loading/unloading surface 20 of the belt 18. Accordingly, the foot 52 and the wheels 54 may cooperate to distribute a weight of the transfer device 32 and/or a weight of the wheelchair-using passenger supported by the transfer device 32 between the chassis 48 of the ride vehicle 30 and the belt 18. The wheels 54 permit minor movement of the transfer device 32 such that any potential speed differential between the loading speed of the ride vehicle 30 (e.g., relative to the stationary platform 22 of the exchange area 16) and the traveling speed of the loading/unloading surface 20 (e.g., relative to the stationary platform 22 of the exchange area 16) does not result in interference between the ride vehicle 30 and the belt 18.

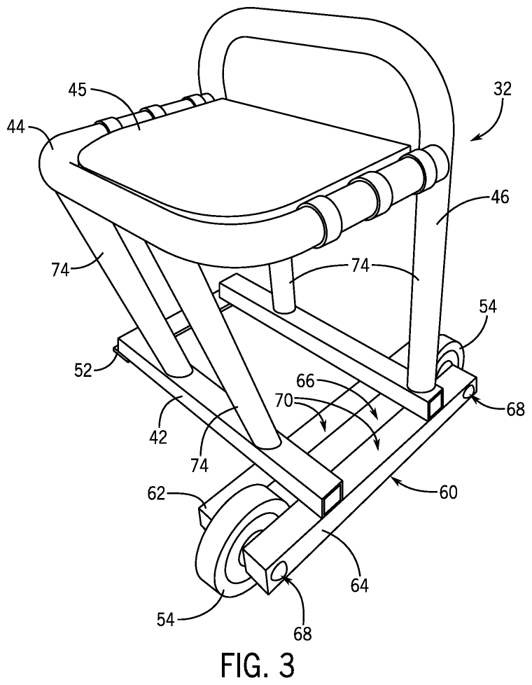

To better illustrate the features of the transfer device 32 disclosed herein, FIG. 3 is a perspective view of an embodiment of the transfer device 32. In the illustrated embodiment, the transfer device 32 includes a roller assembly 60 that is coupled to the lower chassis 42. In an embodiment, the roller assembly 60 includes a first rail 62, such as an inner rail, and a second rail 64, such as an outer rail, which are positioned adjacent to one another and separated by a gap 66. The gap 66 may be configured to receive the wheels 54, which may be rotatably coupled to the first and second rails 62, 64 via respective axle assemblies 68. For example, the axle assemblies 68 may each include an axle shaft that is configured to extend through apertures formed within the first and second rails 62, 64. The axle shafts are configured to engage with corresponding bearings or bushings included in the wheels 54, such that the wheels 54 may be rotatably coupled to the roller assembly 60 via the axle shafts.

Although the illustrated embodiment of the transfer device 32 includes the first rail 62 and the second rail 64, it should be understood that, in other embodiments, the first rail 62 or the second rail 64 may be omitted from the roller assembly 60. Indeed, in such embodiments, the axle assemblies 68 may be configured to support the wheels 54 by means of engagement with the first rail 62 or the second rail 64. Moreover, it should be appreciated that the roller assembly 60 may include any suitable quantity of wheels 54 that are configured to support the transfer device 32. For example, the roller assembly 60 may include 1, 2, 3, 4, 5, or more than five wheels 54.

In certain embodiments, the wheels 54 may be implemented as casters that are configured to pivot (e.g., swivel) relative to the roller assembly 60 to enable the transfer device 32 to translate along various directions. For example, the casters may be configured to pivot about an axis that extends generally orthogonal to a plane formed by respective upper surfaces 70 of the first and second rails 62, 64. In this manner, the casters may enable the transfer device 32 to travel along a contoured path and/or rotate about a stationary point relative to the ground. In further embodiments, the wheels 54 may include tracks or any other suitable rollers or wheels 54 that are configured to facilitate movement of the transfer device 32 across a surface, such as the loading/unloading surface 20.

The transfer device 32 may include one or more support braces 74 that are configured to couple the seating structure 44 to the lower chassis 42. In an embodiment, the support braces 74 and/or the seating structure 44 may be formed from tubing (e.g., round tubing or oval tubing) that may enable a wheelchair-using passenger interacting with the transfer device 32 to comfortably hold the transfer device 32 for support. In other words, the tubing used to construct the support braces 74 and the seating structure 44 may serve as hand rails that enable the wheelchair-using passenger to more easily mount or dismount from the transfer device 32. The lower chassis 42 may be formed from tubing having a quadrilateral cross-section (e.g., square tubing, rectangular tubing) or may be formed from the round or oval tubing used to construct the support rails and/or the seating structure 44. In any case, the tubing used to construct the transfer device 32 may be formed from aluminum, stainless steel, polymers (e.g., plastics), or any other suitable material or combination of materials. The various tubes used to construct the transfer device 32 may be coupled to one another via suitable fasteners, adhesives (e.g., bonding glue), or a metallurgical process (e.g., welding or brazing).

As shown in the illustrated embodiment, the seating structure 44 may include the seating pan 45 that is coupled to the tubing of the seating structure 44 (e.g., via one or more clamps). In an embodiment, the seating pan 45 may include a solid or perforated sheet of material, such as a sheet of aluminum. In certain embodiments, the seating pan 45 may be covered with a cushioning material, such as foam or vinyl, which may enhance a comfort provided by the seating pan 45 when a wheelchair-using passenger is seated on the seating pan 45.

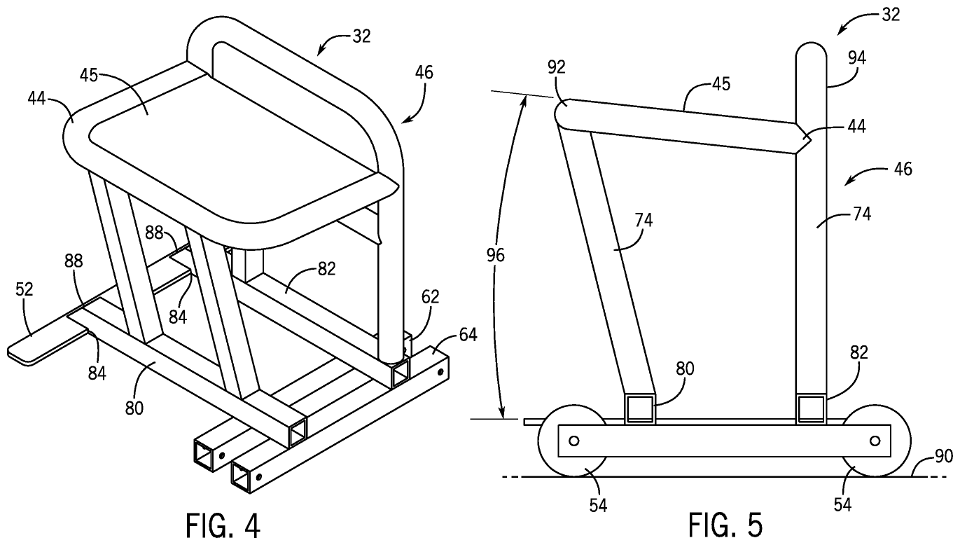

FIG. 4 is a perspective view of an embodiment of the frame 46 of the transfer device 32. In an embodiment, the lower chassis 42 may include a first chassis rail 80 and a second chassis rail 82 that extend generally orthogonal to the first and second rails 62, 64 of the roller assembly 60. As shown in the illustrated embodiment, the foot 52 may be received within respective notches 84 formed within the first and second chassis rails 80, 82. In an embodiment, the foot 52 may be rigidly coupled to the first and second chassis rails 80, 82 (e.g., via a welding process). However, as discussed below, in other embodiments, a position of the foot 52 (e.g., with respect to the first and second chassis rails 80, 82) may be adjustable. The first chassis rail 80, the second chassis rail 82, or both, may include a chamfered end portion 88 that is configured to provide additional clearance between the first chassis rail 80 and/or the second chassis rail 82 and an enclosure (e.g., a decorative body panel) of the ride vehicle 30 during attaching/detaching operations of the transfer device 32 on the ride vehicle 30. Accordingly, the chamfered end portions 88 may ensure that the lower chassis 42 does not interfere with the enclosure (e.g., the chassis 48, a body or aesthetic covering) of the ride vehicle 30 when an operator or other user attempts to transition the transfer device 32 between the engaged configuration 40, in which the transfer device 32 is coupled to the ride vehicle 30, and a disengaged configuration, in which the transfer device 32 is decoupled from the ride vehicle 30.

FIG. 5 is a side view of an embodiment of the transfer device 32. In an embodiment, the seating structure 44 may be configured to position the seating pan 45 at an incline with respect to a ground 90 (e.g., the loading/unloading surface 20). That is, the seating pan 45 may slope downward (e.g., with respect to the ground 90) from a front portion 92 of the seating structure 44 to a rear portion 94 (e.g., a backrest) of the seating structure 44. In an embodiment, the incline of the seating pan 45 may be approximately equal to an incline of a seating structure 44 of typical wheelchairs that may be used by wheelchair-using passengers. Accordingly, a wheelchair-using passenger may be placed in a familiar seating position when transferring from the wheelchair to the transfer device 32. As a non-limiting example, an angle of the incline 96 may be approximately 6 degrees. However, it should be understood that, in other embodiments, the seating pan 45 may be positioned at any other suitable angle with respect to the ground 90.

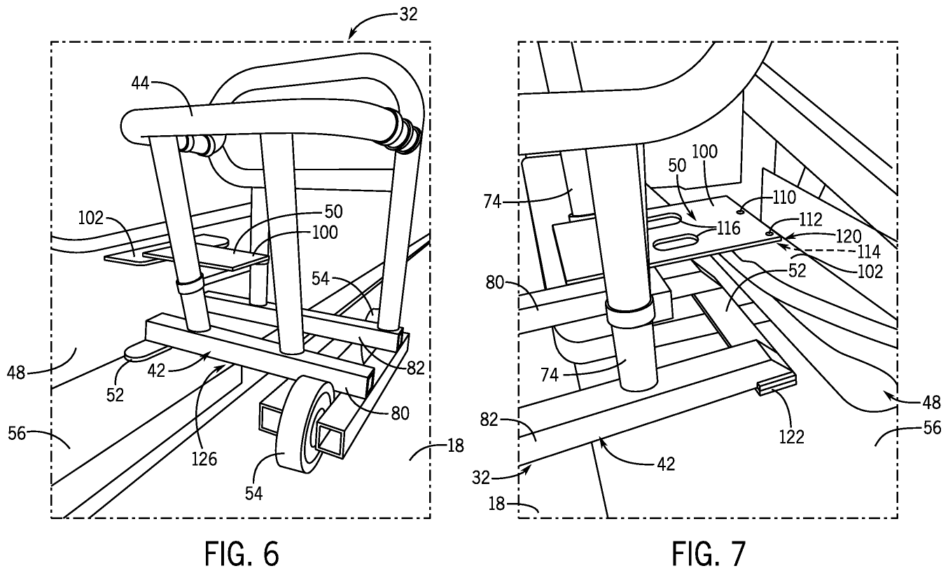

FIG. 6 is a perspective view of an embodiment of the transfer device 32 in the engaged configuration 40, illustrating the transfer device 32 is coupled to the ride vehicle 30 to facilitate loading or unloading of wheelchair-using passengers from the ride vehicle 30. As briefly discussed above, the transfer device 32 may include the interface feature 50 that is configured to facilitate removable coupling of the transfer device 32 to the ride vehicle 30. For example, the interface feature 50 may include a mounting bracket 100 that is coupled to the frame 46 of the transfer device 32 or formed integrally with the frame 46. Particularly, the mounting bracket 100 may be coupled to one or more of the support braces 74 of the frame 46 via suitable fasteners. As discussed in detail below, the mounting bracket 100 may include one or more mating features (e.g., pins, rods, pegs) that extend from the mounting bracket 100 and are configured to engage with complementary mating feature/s (e.g., apertures, recesses) formed within a receiving bracket 102 of the ride vehicle 30. Accordingly, engagement between the pins of the mounting bracket 100 and the apertures of the receiving bracket 102 may enable the interface feature 50 to block lateral movement of the transfer device 32, across the ground 90, relative to the ride vehicle 30. For clarity, as used herein, the mounting bracket 100 and the receiving bracket 102 may be collectively referred to as the interface feature 50.

To better illustrate the engagement between the mounting bracket 100 and the receiving bracket 102, FIG. 7 is a perspective view of an embodiment of a portion of transfer device 32 engaged with the ride vehicle 30. As shown in the illustrated embodiment, the mounting bracket 100 includes a first pin 110 and a second pin 112 that are configured to engage with corresponding apertures 114 formed within the receiving bracket 102 of the ride vehicle 30. It should be understood that the complementary mating features (e.g., pins 110, 112 and apertures 114) of the mounting bracket 100 and the receiving bracket 102 may be exchanged in an embodiment. To couple the transfer device 32 to the ride vehicle 30, an operator of the ride system 10 may first pivot the transfer device 32 in a first direction to lift the foot 52 of the transfer device 32 above an upper surface of the barge board 56. The operator may subsequently translate the transfer device 32 toward the ride vehicle 30 and align the first and second pins 110, 112 with their corresponding apertures 114 formed within the receiving bracket 102. Upon alignment of the first and second pins 110, 112 with the apertures 114, the operator may pivot the transfer device 32 in a second direction, opposite to the first direction, to lower the first and second pins 110, 112 into their respective apertures 114 and to place the foot 52 atop the upper surface of the barge board 56. In certain embodiments, the mounting bracket 100 may include one or more viewing apertures 116 formed therein that enable the operator to more easily determine respective positions of the first and second pins 110, 112 relative to the apertures 114. Accordingly, the viewing apertures 116 may facilitate alignment of the first and second pins 110, 112 with the apertures 114.

In an embodiment, an axial gap 120 may remain between the mounting bracket 100 and the receiving bracket 102 when the foot 52 is placed atop the barge board 56 in the engaged configuration 40 of the transfer device 32. In this manner, the mounting bracket 100 may not be exposed to a force associated with a weight of the transfer device 32 and/or a weight of a wheelchair-using passenger seated on the transfer device 32. Indeed, the axial gap 120 may ensure that the mounting bracket 100 and/or the receiving bracket 102 is not bent or otherwise deformed due to excessive loading placed on either of these brackets 100, 102. Indeed, the foot 52 and the wheels 54 of the transfer device 32 may cooperate to support substantially all of the weight of the transfer device 32 and/or the weight of the wheelchair-using passenger positioned on the transfer device 32. As such, the mounting bracket 100 and the receiving bracket 102 may be sufficiently sized, in particular, to block translational movement (e.g., along a plane defined by the belt 18) of the transfer device 32 relative the ride vehicle 30, instead of to support a weight of the transfer device 32 and/or a weight of the wheelchair-using passenger supported by the transfer device 32. It should be appreciated that, in an embodiment, the apertures 114 of the receiving bracket 102 may be formed (e.g., drilled) within a portion of the chassis 48 of the ride vehicle 30, instead of the receiving bracket 102, such that the receiving bracket 102 may be omitted from the ride vehicle 30. Moreover, in other embodiments, the mounting bracket 100 may be configured to rest on the receiving bracket 102, such that substantially no axial gap extends between the mounting bracket 100 and the receiving bracket 102.

In an embodiment, the first and second pins 110, 112 may include generally cylindrical pegs that each have a diameter that is less than a diameter of the corresponding apertures 114 formed within the receiving bracket 102. Accordingly, an operator of the ride system 10 may more easily align the first and second pins 110, 112 with the apertures 114 when engaging the transfer device 32 with the ride vehicle 30. In other embodiments, the first and second pins 110, 112 may include a generally conical shape that facilitates alignment of the first and second pins 110, 112 with their respective apertures 114 in the receiving bracket 102. In certain embodiments, the first pin 110 and the aperture 114 (e.g., in the receiving bracket 102) associated with the first pin 110 may include a cross-sectional shape that is different from a cross-sectional shape of the second pin 112 and the aperture 114 (e.g., in the receiving bracket 102) associated with the second pin 112. Accordingly, the first pin 110 may be unable to extend into the second aperture 114 of the receiving bracket 102 and the second pin 112 may be unable to extend into the first aperture 114 of the receiving bracket 102. In this manner, the first and second pins 110, 112 may block the mounting bracket 100 from engaging with the receiving bracket 102 in a misaligned manner.

In certain embodiments, the first and second pins 110, 112 and the receiving bracket 102 may be formed from the same material type. Suitable bushings (e.g., replaceable bushing) may be placed within the apertures 114 and configured to receive the first and second pins 110, 112. Accordingly, such bushings may reduce or substantially eliminate wear (e.g., abrasion) that may occur between the first and second pins 110, 112 and the apertures 114 after multitudinous use cycles of the transfer device 32. In further embodiments, the first and second pins 110, 112 may be formed form a material that is softer (e.g., more malleable) than a material from which the receiving bracket 102 is formed. Accordingly, the first and second pins 110, 112 may incur wear over time instead of the corresponding apertures 114 formed in the receiving bracket 102, and may be replaced upon incurring such wear. That is, the first and second pins 110, 112 may be removable coupled to the mounting bracket 100 to enable removable and replacement of the first and second pins 110, 112.

In an embodiment, a spacer 122 may be coupled to a lower surface of the foot 52 and configured to contact the barge board 56 when the transfer device 32 is in the engaged configuration 40 with the ride vehicle 30. The spacer 122 may be formed from, for example, rubber, cork, polymeric materials, or other suitable materials that may be configured to mitigate or substantially reduce wear (e.g., scratching) of the barge board 56 due to repeated engagement with the foot 52. A thickness of the spacer 122 may be selected to ensure that the axial gap 120 between the mounting bracket 100 and the receiving bracket 102 has a desired width. Indeed, in the illustrated configuration of the transfer device 32, increasing a thickness of the spacer 122 may increase a width of the axial gap 120, while decreasing a thickness of the spacer 122 may decrease a width of the axial gap 120. However, in other embodiments, a width of the axial gap 120 may be adjusted by adjusting a position of the mounting bracket 100 along the support braces 74 of the frame 46.

In certain embodiments, the thickness of the spacer 122 may be adjusted to orient the transfer device 32 at a particular angle relative to, for example, the barge board 56 of the ride vehicle 30. For example, an elongated gap 126, as shown in FIG. 6, may extend between a lower surface of the first and second chassis rails 80, 82 and an upper surface of the barge board 56. In an embodiment, it may be desirable to maintain the first and second chassis rails 80, 82 substantially parallel to the barge board 56, such that a width of the elongated gap 126 is substantially constant along a length of the elongated gap 126. The width of the spacer 122 may therefore be selected such that the first and second chassis rails 80, 82 are oriented generally parallel relative to the barge board 56. As such, the spacer 122 may ensure that first and second chassis rails 80, 82 do not interfere with (e.g., contact), for example, an edge of the barge board 56.

In certain embodiments, a position of the foot 52 itself may be adjustable relative to the lower chassis 42. For example, the foot 52 may be coupled to the first and second chassis rails 80, 82 via adjustable couplers (e.g. threaded shafts), which may be used to adjust the position of the foot 52 relative to the lower chassis 42 (e.g., to move a position of the foot 52 closer to or further away from the lower chassis 42).

It should be appreciated that, in an embodiment, the foot 52 and/or the mounting bracket 100 may be exchangeable with various feet and/or mounting brackets that are configured (e.g., designed, shaped) to effectively interface with a variety of unique ride vehicles 12. Accordingly, by reconfiguring the transfer device 32 based on the ride vehicle 12 with which the transfer device 32 is to be employed, an individual transfer device 32 may be utilized to facilitate loading and unloading of wheelchair-using passengers from a variety of different ride vehicles 12.

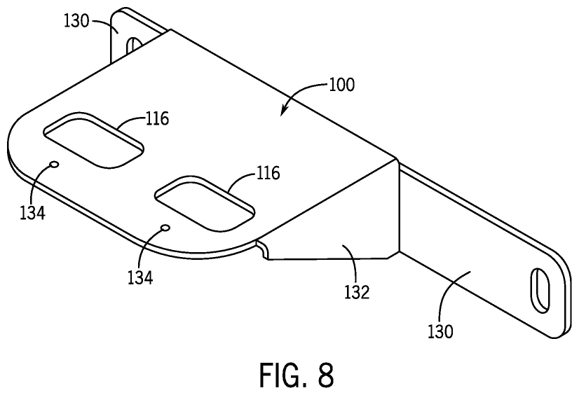

FIG. 8 is a perspective view of an embodiment of the mounting bracket 100. The mounting bracket 100 may include flanges 130 that enable suitable fasteners to couple the mounting bracket 100 to respective receiving flanges of the frame 46 of the transfer device 32. In an embodiment, the mounting bracket 100 may include gussets 132 configured to enhance a structural rigidity of the mounting bracket 100. As discussed above, the mounting bracket 100 may include the viewing apertures 116 that may facilitate alignment of the first and second pins 110, 112 with the apertures of the receiving bracket 102. In an embodiment, the mounting bracket 100 may include fastening apertures 134 that enable suitable fasteners to removably couple the first and second pins 110, 112 to the mounting bracket 100.

As set forth above, embodiments of the present disclosure may provide one or more technical effects useful for transferring wheelchair-using passengers to and from a ride seat of a ride vehicle from a respective wheelchair or other mobile chair of the wheelchair-using passengers. In particular, the transfer device disclosed herein may facilitate transferring of wheelchair-using passengers to and from non-stationary ride vehicles traveling along a loading/unloading area of an amusement park ride. The transfer device of the disclosed embodiments may be used in conjunction with ride vehicles with conventional seats, thereby permitting wheelchair-using passengers to enjoy rides with their companions and without requiring specially-adapted ride seats. The transfer device as disclosed may be used in conjunction with a variety of ride vehicle types. The technical effects and technical problems in the specification are examples and are not limiting. It should be noted that the embodiments described in the specification may have other technical effects and can solve other technical problems.

While only certain features and embodiments have been illustrated and described, many modifications and changes may occur to those skilled in the art (e.g., variations in sizes, dimensions, structures, shapes and proportions of the various elements, values of parameters (e.g., temperatures, pressures, etc.), mounting arrangements, use of materials, colors, orientations, etc.) without materially departing from the novel teachings and advantages of the disclosed subject matter. The order or sequence of any process or method steps may be varied or re-sequenced according to alternative embodiments. It is, therefore, to be understood that the appended claims are intended to cover all such modifications and changes as fall within the true spirit of the invention. Furthermore, in an effort to provide a concise description of the exemplary embodiments, all features of an actual implementation may not have been described. It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A transfer device configured to support a passenger for transfer from a mobile chair to a ride seat of a ride vehicle, comprising:
a frame coupled to a seating portion configured to support the passenger;
at least one wheel coupled to the frame; and
a mounting bracket coupled to the frame and configured to reversibly engage with the ride vehicle, wherein, when in an engaged configuration, the transfer device is coupled to the ride vehicle such that a seating pan of the seating portion is aligned with the ride seat of the ride vehicle and wherein the transfer device is configured to travel with the ride vehicle while the ride vehicle travels along a track when engaged.

2. The transfer device of claim 1, wherein the mounting bracket comprises a mating feature configured to mate with a complementary feature of the ride vehicle.

3. The transfer device of claim 1, comprising a foot coupled to the frame, wherein the foot is configured to engage with a chassis of the ride vehicle and the at least one wheel is configured to move relative to a surface to travel with the ride vehicle when the transfer device is engaged with the ride vehicle.

4. The transfer device of claim 1, wherein the seating portion is oriented at an incline with respect to a translating loading surface upon which the at least one wheel is positioned such that the seating portion slopes downwardly toward the translating loading surface from a front portion of the seating portion to a rear portion of the seating portion.

5. The transfer device of claim 1, wherein the ride vehicle comprises at least one pin extending therefrom, wherein the mounting bracket comprises at least one aperture formed therein, and wherein the at least one pin of the ride vehicle is configured to engage with the at least one aperture of the mounting bracket in the engaged configuration of the transfer device.

6. The transfer device of claim 1, wherein the mounting bracket comprises at least one pin extending therefrom, wherein the ride vehicle comprises a receiving bracket having at least one aperture formed therein, and wherein the at least one pin of the mounting bracket is configured to engage with the at least one aperture of the receiving bracket in the engaged configuration of the transfer device.

7. The transfer device of claim 6, wherein the at least one pin comprises a first pin and a second pin and the at least one aperture comprises a first aperture and a second aperture, wherein respective cross-sectional shapes of the first pin and the first aperture are different than respective cross-sectional shapes of the second pin and the second aperture to block engagement of the first pin with the second aperture and engagement of the second pin with the first aperture.

8. The transfer device of claim 6, wherein the at least one pin is removably coupled to the mounting bracket.

9. The transfer device of claim 1, wherein the frame comprises an inner rail and an outer rail separated by a gap, wherein the at least one wheel extends through the gap and is positioned between the inner and outer rails, and wherein an axle assembly is configured to extend through the inner and outer rails to rotatably couple the at least one wheel to the inner and outer rails.

10. A passenger transfer system, comprising:
a ride vehicle configured to move along a track of an amusement park attraction and having a ride vehicle seating pan configured to support a passenger;
a loading belt positioned adjacent to the track and having a loading surface configured to translate along the track with the ride vehicle; and
a transfer device configured to removably couple to the ride vehicle, wherein the transfer device is configured to support the passenger as the passenger transfers from a mobile chair positioned on the loading belt to the ride vehicle seating pan of the ride vehicle.

11. The passenger transfer system of claim 10, wherein the transfer device comprises at least a portion of an interface feature configured to removably couple the transfer device to the ride vehicle, wherein the interface feature comprises a mounting bracket having a pin extending therefrom.

12. The passenger transfer system of claim 11, wherein the interface feature further comprises a receiving bracket coupled to the ride vehicle and comprising an aperture formed therein, wherein the transfer device is configured to removably couple to the ride vehicle via engagement of the pin with the aperture.

13. The passenger transfer system of claim 10, wherein the transfer device comprises a foot configured to engage with a chassis of the ride vehicle in an engaged configuration of the transfer device and a wheel configured to engage with the loading belt, wherein the foot and the wheel are configured to support a weight of the transfer device and a weight of the passenger in the engaged configuration of the transfer device.

14. The passenger transfer system of claim 13, wherein the foot is coupled to a lower chassis of the transfer device, wherein a gap extends between the lower chassis and the chassis of the ride vehicle in the engaged configuration of the transfer device.

15. The passenger transfer system of claim 10, wherein the transfer device is positioned in contact with and between the ride vehicle and the mobile chair when engaged with the ride vehicle.

16. The passenger transfer system of claim 10, wherein a seating pan of the transfer device is aligned with the ride vehicle seating pan when in an engaged configuration such that height differences between the seating pan of the transfer device and the ride vehicle seating pan are within a predetermined tolerance.

17. A transfer device configured to support a passenger as the passenger transfers from a mobile chair to a ride vehicle seating pan of a ride vehicle, comprising:
a frame, comprising:
a lower chassis having a foot and at least one wheel rotatably coupled to the lower chassis; and
a seating portion coupled to the lower chassis and configured to support the passenger; and
a mounting bracket coupled to the frame and configured to engage with the ride vehicle in an engaged configuration and to be removed from the ride vehicle in a disengaged configuration, wherein, in the engaged configuration, the transfer device is coupled to the ride vehicle and configured to travel with the ride vehicle and wherein at least a portion of the ride vehicle seating pan is aligned with a seating pan on the transfer device in the engaged configuration.

18. The transfer device of claim 17, wherein a translating loading surface is configured to travel along a track of the ride vehicle with the ride vehicle, wherein, in the engaged configuration of the transfer device, the foot is configured to engage with a chassis of the ride vehicle and the at least one wheel is configured to engage with the translating loading surface such that the transfer device moves together with the ride vehicle.

19. The transfer device of claim 18, wherein, in the engaged configuration of the transfer device, the foot and the wheel are configured to support a weight of the transfer device and a weight of the passenger such that the mounting bracket does not support the weight of the transfer device and the weight of the passenger.

20. The transfer device of claim 17, wherein the lower chassis structure is constructed of square tubing or rectangular tubing, and the seating portion is constructed of round tubing or oval tubing.
